(19) United States
(12) Patent Application Publication
(10) Pub. No.: US 2011/0164146 A1
(43) Pub. Date: Jul. 7, 2011

(54) Adaptive Frame Rate Control System and Method for an Image Sensor

(75) Inventors: Tony CHIANG, TAINAN (TW); Amit MITTRA, TAINAN (TW)

(73) Assignee: HIMAX IMAGING, INC., Grand Cayman (KY)

(21) Appl. No.: 12/683,928

(22) Filed: Jan. 7, 2010

(51) Int. Cl. H04N 5/235

(52) U.S. Cl. 348/229.1; 348/E05.037

(57) ABSTRACT

An adaptive frame rate control system and method for an image sensor includes an amplifier which amplifies a sensor output signal of the image sensor with a gain. An automatic exposure gain (AEG) controller determines a product of exposure time and the gain (EGP) based on incident light intensity, and controls a timing controller and the amplifier, to adjust the exposure time and the gain of the image sensor such that the amplified sensor output signal may approximately approach a sensor target signal, where the change of the exposure time is preferred over the change of the gain.

### BACKGROUND OF THE INVENTION

1. Field of the Invention

The present invention generally relates to an image sensor, and more particularly to adaptively controlling the frame rate in an image sensor.

2. Description of Related Art

Semiconductor based image sensors such as complementary metal-oxide-semiconductor (CMOS) sensors are widely used in, for example, cameras and camcorders, to capture light energy and convert it to electrical signals. The signals are amplified, digitized and then processed to construct an image. The amount of the light energy captured by the image sensor is proportional to the exposure time during which the active sensing area of the image sensor is exposed. Thus, longer exposure times result in more energy being collected.

The length of the exposure time is generally determined by two primary factors: the measured incident light relative to the desired signal level, and the sensor frame rate. Regarding the former, in a dark lighting condition, for example, longer exposure time is required in order to reach the desired signal level. Regarding the latter, the frame rate is mostly determined according to the relevant application, and it sets the limits of the maximum exposure time.

Amplifiers are conventionally used to amplify the sensor output signals to achieve the desired signal level. Compared to increasing exposure time, amplifying the sensor output signal will never decrease the frame rate. However, since increasing signal gain disadvantageously increases noise and therefore reduces overall image quality, such is therefore typically used only when more signal is required beyond the maximum exposure limit.

For the reason that conventional image sensing systems or methods could not effectively optimize sensor noise performance, a need has arisen to propose a novel system and method for dynamically controlling the frame rate in the image sensor in order to optimize the sensor noise performance (e.g., signal-to-noise ratio, SNR) with respect to the frame rate.

### SUMMARY OF THE INVENTION

In view of the foregoing, it is an object of the embodiment of the present invention to provide a system and method for adaptively controlling the frame rate in an image sensor in order to optimize sensor noise performance (e.g., signal-to-noise ratio, SNR).

According to the embodiments of the present invention, an amplifier, such as a programmable gain amplifier, amplifies a sensor output signal of the image sensor with a gain. An automatic exposure gain (AEG) controller determines a product of exposure time and the gain (EGP) based on incident light intensity, and controls a timing controller and the programmable gain amplifier, thereby adjusting the exposure time and the gain of the image sensor such that the amplified sensor output signal may approximately approach a sensor target signal, wherein the change of the exposure time is preferred over the change of the gain. In one embodiment, multiple sets of maximum exposure limits and gain limits are provided by the AEG controller in respective time intervals to the timing controller and the amplifier, respectively, in adjusting the exposure time and the gain of the image sensor. In another embodiment, multiple sets of sensor clocks and gain limits are provided by the AEG controller in respective time intervals to the timing controller and the amplifier, respectively, in adjusting the exposure time and the gain of the image sensor.

### BRIEF DESCRIPTION OF THE DRAWINGS

FIG. 1 is a functional block diagram of a system for adaptive frame rate control in an image sensor according to one embodiment of the present invention;

FIG. 2 shows exemplary timing diagrams of some parameters of concern in FIG. 1;

FIG. 3 is a functional block diagram of a system for adaptive frame rate control in an image sensor according to another embodiment of the present invention; and

FIG. 4 shows exemplary timing diagrams of some parameters of concern in FIG. 3.

### DETAILED DESCRIPTION OF THE INVENTION

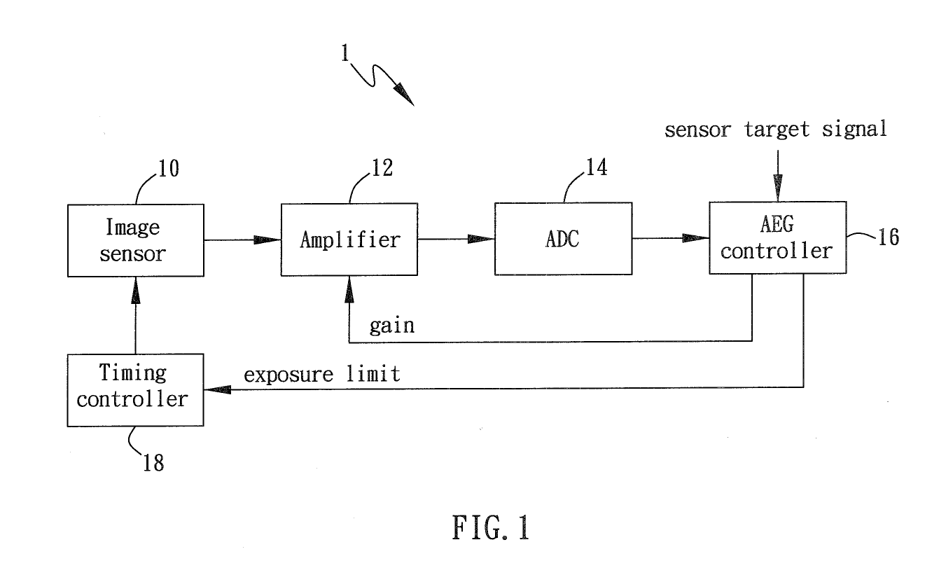

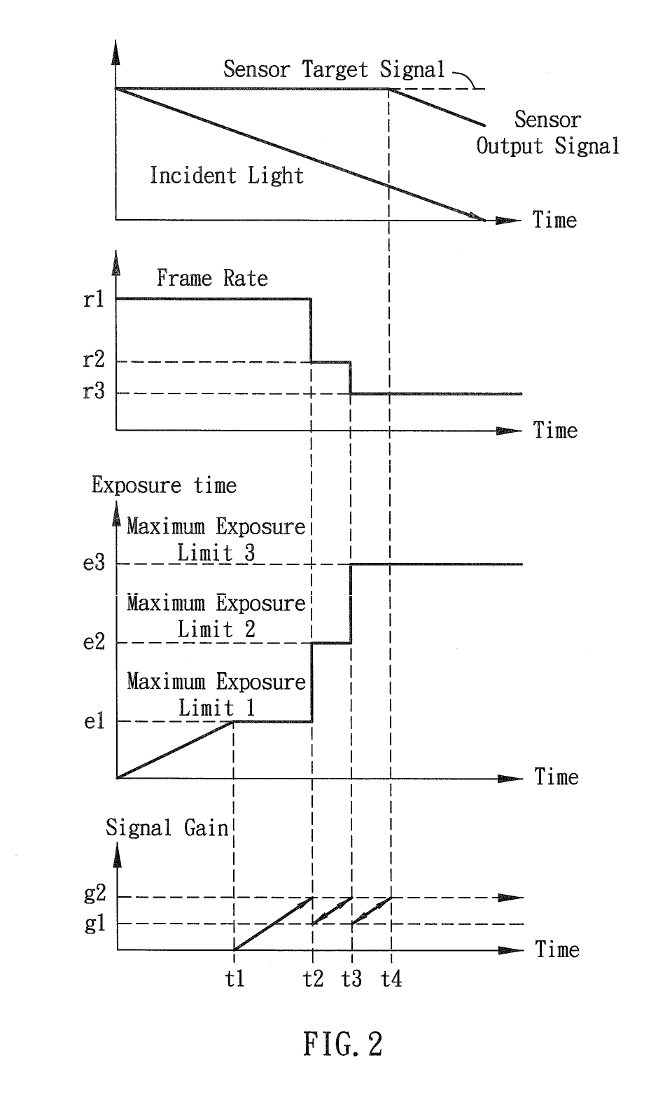

FIG. 1 shows a functional block diagram of a system for adaptive frame rate control, embodied as an adaptive frame rate control system 1 in an image sensor 10, according to one embodiment of the present invention. FIG. 2 shows exemplary timing diagrams of some parameters concerning the embodiment of FIG. 1. In the embodiment, the image sensor 10 may be a complementary metal-oxide-semiconductor (CMOS) image sensor (“CIS”), and the image sensor 10 may, in general, be a semiconductor based image sensor. The adaptive frame rate control system 1, in the embodiment, includes at least an amplifier 12, an automatic exposure gain (AEG) controller 16 and a timing controller 18. Specifically, the amplifier 12, embodied, for example, as a programmable gain amplifier, is used to amplify the sensor output signal of the image sensor 10 with a gain (or signal amplification), which is controllably provided by the AEG controller 16. The amplified sensor output signal from the amplifier 12 may preferably be converted into a digital form by an analog-to-digital converter (ADC) 14, and subsequently be processed in the digital field/domain by the AEG controller 16. The AEG controller 16, along with the timing controller 18, is employed to adaptively adjust the exposure time and the gain such that the sensor output signal may approach a sensor target signal (FIG. 2).

Specifically, the AEG controller 16 firstly determines the value of the product of the exposure time and the gain (“exposure gain product” or EGP) of a current frame or frames required to reach the desired sensor target signal based on the intensity of incident light. Based on the determined EGP, one or more of the exposure time and the gain are then adaptively adjusted to optimize sensor noise performance (e.g., signal-to-noise ratio, SNR) with respect to frame rate. In the embodiment, increasing the exposure time is preferred over increasing the gain for the reason that more signal amplification (or gain) introduces more noise and therefore reduces overall image quality. Likewise, reducing the gain is preferred over reducing the exposure time. For instance, an algorithm may favor changes in exposure time over non-reducing changes in (i.e., adjustments that do not decrease, that change, and/or that increase) the gain, or an algorithm may exhibit a preference in changing (or a bias or propensity to change) exposure time over increasing the gain. This type of approach, preference, paradigm, or algorithm (e.g., rule) is generally adopted in the embodiment under some constraints that will become evident from the following paragraphs.

Referring to FIG. 2, multiple sets of maximum exposure limits and gain limits are used in the embodiment. For example, a maximum exposure limit 1 (e1) is used within a first time interval t1-t2, a maximum exposure limit 2 (e2) is used within a second time interval t2-t3, and a maximum exposure limit 3 (e3) is used within a third time interval t3-t4. In each of the time intervals, there are a corresponding maximum gain limit g2 and minimum gain limit g1. Although the maximum gain limit g2 and minimum gain limit g1 are the same in each time interval, it is appreciated that each time interval may use its respective and distinct set of gain limits g1/g2. In the embodiment, the maximum exposure limits are set at distinct intervals at or greater than the frame height (or maximum number of rows of the cells in the image sensor 10). As the maximum limits of the exposure are set equal to or greater than the frame height, the utilization of distinct maximum exposure limits will directly and determinedly adjust the frame rate.

In an operation of the adaptive frame rate control system 1, as the incident light intensity, for example, decreases in the first time interval t1-t2, the gain provided by the AEG controller 16 (to the amplifier 12) accordingly increases toward but not over/exceeding the maximum gain limit g2, while the exposure time provided by the AEG controller 16 (to the timing controller 18) is maintained at the maximum exposure limit 1 (e1). It is noted that a first frame rate r1 is correspondingly obtained in this time interval t1-t2.

When the incident light intensity further decreases to the extent that the determined exposure gain product (EGP) exceeds the product of the maximum exposure limit 1 (e1) and the maximum gain limit g2, that is, EGP>e1×g2, another maximum exposure limit (e.g., the maximum exposure limit 2 (e2)) now replaces the preceding one. As the incident light intensity, for example, decreases in the second time interval t2-t3, the gain provided by the AEG controller 16 (to the amplifier 12) accordingly increases from the minimum gain limit g1 toward but not over/exceeding the maximum gain limit g2, while the exposure time provided by the AEG controller 16 (to the timing controller 18) is maintained at the maximum exposure limit 2 (e2). It is noted that a (lower) second frame rate r2 is correspondingly obtained in this time interval t2-t3.

Likewise, when the incident light intensity further decreases to the extent that the determined exposure gain product (EGP) exceeds the product of the maximum exposure limit 2 (e2) and the maximum gain limit g2, that is, EGP>e2×g2, another maximum exposure limit (e.g., the maximum exposure limit 3 (e3)) now replaces the preceding one. As the incident light intensity, for example, decreases in the third time interval t3-t4, the gain provided by the AEG controller 16 (to the amplifier 12) accordingly increases from the minimum gain limit g1 toward but not over/exceeding the maximum gain limit g2, while the exposure time provided by the AEG controller 16 (to the timing controller 18) is maintained at the maximum exposure limit 3 (e3). It is noted that a (even lower) third frame rate r3 is correspondingly obtained in this time interval t3-t4. It is assumed that, in the embodiment, the third frame rate r3 is the acceptably lowest frame rate, below which motion blur incurs. Consequently, the sensor output signal deviates from the sensor target signal while the incident light intensity still decreases and the exposure time and the gain are maintained unchanged as shown in FIG. 2.

According to the operation described above, once the exposure limit has been set, the gain is applied from the minimum gain limit g1 until the maximum gain limit g2 is reached. The AEG controller 16 accordingly redistributes the exposure gain product in favor of applying higher exposure than gain. The redistribution will result in reduction of the frame rate and the gain, thereby improving noise performance and obtaining better signal-to-noise ratio (SNR).

As the preceding paragraphs describe the operation concerning the decreased incident light intensity, the timing diagrams may be traced backward for describing the conditions in which the incident light intensity is increasing from low to high. In other words, the maximum exposure limit may be changed from the maximum exposure limit 3 (e3) to the maximum exposure limit 2 (e2) (in the time interval t2-t3) when the incident light intensity increases to the extent that the determined exposure gain product (EGP) becomes smaller than the product of the maximum exposure limit 3 (e3) and the minimum gain limit g1, that is, EGP<e3×g1. The maximum exposure limit may be further changed from the maximum exposure limit 2 (e2) to the maximum exposure limit 1 (e1) (in the time interval t1-t2) when the incident light intensity still increases to the extent that the determined exposure gain product (EGP) becomes smaller than the product of the maximum exposure limit 2 (e2) and the minimum gain limit g1, that is, EGP<e2×g1.

Conclusively speaking, a distinct exposure limit is set whenever the maximum gain limit g2 or the minimum gain limit g1 has been reached in the respective time interval. Specifically, the exposure limit is decreased in a case where the maximum gain limit g2 has been reached in the respective time interval, and the exposure limit is increased in a case where the minimum gain limit g1 has been reached in the respective time interval.

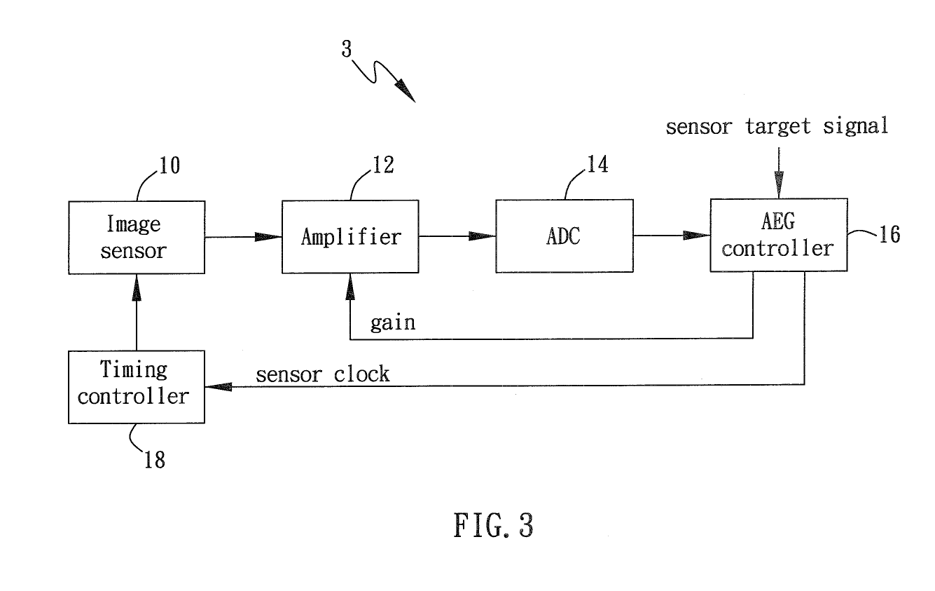

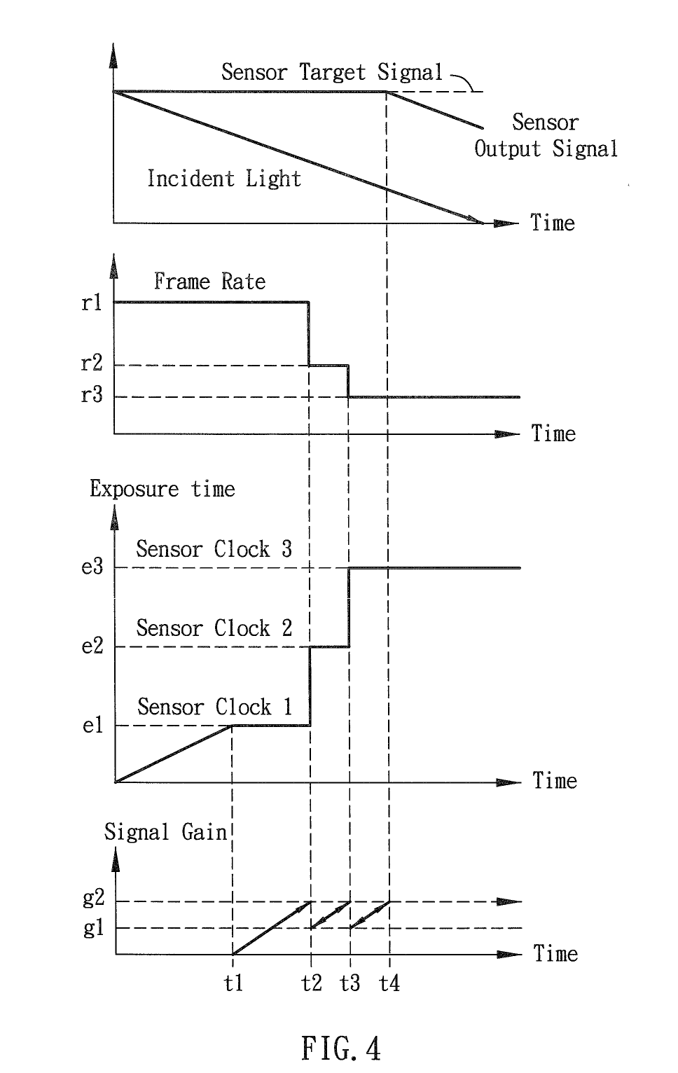

FIG. 3 is a functional block diagram depicting a system 3 for adaptive frame rate control in an image sensor 10 according to another embodiment of the present invention. FIG. 4 shows exemplary timing diagrams of some parameters concerned in the depiction of FIG. 3. Reference numerals the same as those in FIG. 1 are used for the blocks, the configuration descriptions of which are omitted for brevity.

In the present embodiment, multiple sensor clocks, rather than the exposure limits of the previous embodiment, are provided (from the AEG controller 16) to the timing controller 18. As the sensor clock decides the exposure time, each sensor clock determines its respective exposure time. For example, the sensor clock 1 corresponds to a first exposure time e1, the (smaller) sensor clock 2 corresponds to a second exposure time e2, and the (even smaller) sensor clock 3 corresponds to a third exposure time e3.

The operation (in FIG. 3 and FIG. 4) of the adaptive frame rate control system 3 is similar to that (in FIG. 1 and FIG. 2) of the adaptive frame rate control system 1. The primary difference is that distinct sensor clock, rather than the exposure limit, is set whenever the maximum gain limit g2 or the minimum gain limit g1 has been reached in the respective time interval. Specifically, the sensor clock is decreased in a case where the maximum gain limit g2 has been reached in a respective time interval, and the sensor clock is increased in a case where the minimum gain limit g1 has been reached in a respective time interval.

Although specific embodiments have been illustrated and described, it will be appreciated by those skilled in the art that various modifications may be made without departing from the scope of the present invention, which is intended to be limited solely by the appended claims.

What is claimed is:

1. An adaptive frame rate control system for an image sensor, comprising:
an amplifier configured to amplify a sensor output signal of the image sensor with a gain, thereby to generate an amplified sensor output signal; and
an automatic exposure gain (AEG) controller arranged and coupled to control both the amplifier and a timing controller and to determine a product of exposure time and the gain (EGP) based on incident light intensity, thereby the AEG controller, the amplifier and the timing controller adaptively adjusting one or more of the exposure time and the gain of the image sensor according to an algorithm exhibiting a preference in changing exposure time over increasing the gain, such that the amplified sensor output signal may approximately approach a sensor target signal.

2. The system of claim 1, further comprising an analog-to-digital converter (ADC) for converting the amplified sensor output signal into a digital-form equivalent, which may subsequently be processed by the AEG controller.

3. The system of claim 1, wherein a plurality of sets of maximum exposure limits and gain limits are provided by the AEG controller in respective time intervals to the timing controller and the amplifier, respectively, in adjusting the exposure time and the gain of the image sensor.

4. The system of claim 3, wherein the maximum exposure limit in the respective time interval is replaced by another maximum exposure limit whenever the gain limit has been reached.

5. The system of claim 4, wherein the gain limits include a maximum gain limit and a minimum gain limit.

6. The system of claim 5, when the incident light intensity decreases, the gain accordingly increases toward but not over the maximum gain limit while the maximum exposure limit is maintained unchanged; and when the incident light intensity increases, the gain accordingly decreases toward but not below the minimum gain limit while the maximum exposure limit is maintained unchanged.

7. The system of claim 1, wherein a plurality of sets of sensor clocks and gain limits are provided by the AEG controller in respective time intervals to the timing controller and the amplifier, respectively, in adjusting the exposure time and the gain of the image sensor.

8. The system of claim 7, wherein the sensor clock in the respective time interval is replaced by another sensor clock whenever the gain limit has been reached.

9. The system of claim 8, wherein the gain limits include a maximum gain limit and a minimum gain limit.

10. The system of claim 9, when the incident light intensity decreases, the gain accordingly increases toward but not over the maximum gain limit while the sensor clock is maintained unchanged; and when the incident light intensity increases, the gain accordingly decreases toward but not below the minimum gain limit while the sensor clock is maintained unchanged.

11. An adaptive frame rate control method for an image sensor, comprising:
amplifying a sensor output signal of the image sensor with a gain to generate an amplified sensor output signal;
determining a product of exposure time and the gain (EGP) based on incident light intensity; and
adaptively adjusting the exposure time and the gain of the image sensor such that the amplified sensor output signal may approximately approach a sensor target signal, wherein the adjusting exhibits a bias or preference of changing the exposure time over increasing the gain.

12. The method of claim 11, further comprising a step of converting the amplified sensor output signal into a digital-form equivalent before the amplified sensor output signal is subsequently processed.

13. The method of claim 11, wherein a plurality of sets of maximum exposure limits and gain limits are provided in respective time intervals in adjusting the exposure time and the gain, respectively, of the image sensor.

14. The method of claim 13, wherein the maximum exposure limit in the respective time interval is replaced by another maximum exposure limit whenever the gain limit has been reached.

15. The method of claim 14, wherein the gain limits include a maximum gain limit and a minimum gain limit.

16. The method of claim 15, when the incident light intensity decreases, the gain accordingly increases toward but not over the maximum gain limit while the maximum exposure limit is maintained unchanged; and when the incident light intensity increases, the gain accordingly decreases toward but not below the minimum gain limit while the maximum exposure limit is maintained unchanged.

17. The method of claim 11, wherein a plurality of sets of sensor clocks and gain limits are provided in respective time intervals in adjusting the exposure time and the gain, respectively, of the image sensor.

18. The method of claim 17, wherein the sensor clock in the respective time interval is replaced by another sensor clock whenever the gain limit has been reached.

19. The method of claim 18, wherein the gain limits include a maximum gain limit and a minimum gain limit.

20. The method of claim 19, when the incident light intensity decreases, the gain accordingly increases toward but not over the maximum gain limit while the sensor clock is maintained unchanged; and when the incident light intensity increases, the gain accordingly decreases toward but not below the minimum gain limit while the sensor clock is maintained unchanged.
